(19) United States
(12) Patent Application Publication
(10) Pub. No.: US 2010/0311459 A1
(43) Pub. Date: Dec. 9, 2010

(54) MOBILE RADIO SYSTEMS HAVING GROUPS WITH DYNAMIC LABELS

(75) Inventor: David Alan Holland, Christchurch (NZ)

Correspondence Address: SNR DENTON US LLP, P.O. BOX 061080, CHICAGO, IL, 60606-1080, US

(73) Assignee: TAIT ELECTRONICS LIMITED, Christchurch (NZ)

(21) Appl. No.: 12/780,618

(22) Filed: May 14, 2010

Related U.S. Application Data
(60) Provisional application No. 61/218,015, filed on Jun. 17, 2009.

(30) Foreign Application Priority Data
May 15, 2009 (NZ) 577009

(51) Int. Cl. H04B 7/00

(52) U.S. Cl. 455/518; 455/521

(57) ABSTRACT

Radio units of a radio communication system are grouped by selecting one or more radio units in the system to form a group, selecting an identification code for the group, determining an alphanumeric label for the group, sending a new group message to each of the selected radios containing the identification code and the label, and storing the code and the label at each of the selected radios. These operations may be performed by a dispatcher terminal for a radio communication system. Each radio unit of the radio communication system is configured to receive a regrouping message containing a group identification code and an alphanumeric label from the dispatcher terminal, and create a data record that represents the new group in its memory.

### RELATED APPLICATIONS

This application claims priority to and incorporates by reference New Zealand Patent Application 577009, filed 15 May 2009, and U.S. Provisional Patent Application 61/218,015, filed 17 Jun. 2009.

### FIELD OF THE INVENTION

The present invention relates to radio communication systems and particularly to trunked mobile radio systems which provide dynamic regrouping.

### BACKGROUND

Trunked mobile radio systems are commonly used by public safety organisations such as police, fire and rescue services where radios are usually grouped according to current activities of the users. A detailed discussion of trunked mobile systems and dynamic regrouping can be found in a range of earlier patents and other resources, such as U.S. Pat. No. 5,117,501. In general terms, a trunked network allows radios to communicate in groups, often called talkgroups for voice calls and datagroups for data calls, and allocates repeater channels to the groups on a variable basis, according to actual usage. Groups may be fixed or dynamic. In conventional systems the channels are used without dynamic control or arbitration which can cause some users to be blocked from making simultaneous calls

Trunked systems usually include one or more terminals, operated by dispatchers, who are responsible for overall management of communications in the network, and particularly for regrouping radios. A dispatcher can select individual radios on a display, allocate a group identification code or ID, and transmit regroup messages containing the ID to the radios through the network. During a fire emergency for example, radios from an existing fire department group might need to be temporarily grouped with radios from a local police group. The members and purpose of this group may change during the emergency.

Group IDs are numerical and must be selected from a list of existing IDs, such as a range from 900 to 999. Some group IDs are fixed and will have been pre-programmed in the radios. They may be associated with a fixed label or alias such as “Fire group A” or “Police group B” which is displayed to the dispatcher on the terminal, and will also have been pre-programmed in the appropriate radios for display to the users. Other group IDs are available for selection during regroup procedures. The dispatcher may be able to add a label in relation to a new group, for display on the console, but these labels are not available to the users of a new group.

### SUMMARY OF THE INVENTION

It is an object of the invention to provide for improved regrouping procedures in radio communication systems, or at least to provide an alternative to existing regroup procedures.

In one aspect the invention may broadly be said to reside in a method of grouping radio units in a radio communication system, including: selecting one or more radio units in the system to form a group, selecting an identification code for the group, determining an alphanumeric label for the group, sending a new group message to each of the selected radios, containing the identification code and the label, and storing the code and the label at each of the selected radios.

The method may further include: determining a new alphanumeric label for the group, sending an update message to the radios in the group, containing the identification code and the new label, and updating the label stored at each radio in the group. The method may also further include: initiating a call to the group, and displaying the label at one or more of the units during the call.

In another aspect the invention broadly resides in a dispatcher terminal for a radio communication system, including: a processor, and a memory coupled to the processor for storing instructions which when executed enable the processor to: indicate radio units available for a new group in the communication system, receive a selection of one or more radio units from the available units, indicate available group identification codes for the new group, receive a selection of a code from the available identification codes, display an input area for an alphanumeric label for the new group, receive an alphanumeric label from the input area, create a data record representing the new group in the memory, and send a regrouping message to each of the selected radio units in the new group, containing the group code and the alphanumeric label.

Preferably the instructions in the terminal further enable the processor to: indicate existing groups in the communication system, receive a selection of a group from the existing groups, display an input area for a new alphanumeric label for the selected group, receive an alphanumeric label from the input area, update a data record representing the group in the memory with the received label, send an update message to each radio in the group, containing the group identification code and the new alphanumeric label for the group.

Preferably the instructions in the terminal further enable the processor to: display existing groups in the communication system, represent each existing group with an identification code and an alphanumeric label, receive a selection of a group from the existing groups, and initiate a group call to the selected group.

In a further aspect the invention broadly resides in a radio unit for a radio communication system, including: a processor, and a memory coupled to the processor for storing instructions which when executed enable the processor to: receive a regrouping message from a dispatcher terminal, containing a group identification code and an alphanumeric label for a new group, and create a data record in the memory representing the new group.

Preferably the instructions in the radio unit further enable the processor to: receive an update message containing a group identification code and a new alphanumeric label for a group, access a data record in the memory for a group identified by the code, and update the data record with the new alphanumeric label.

Preferably the instructions in the radio unit further enable the processor to: receive a group call message containing a group identification code, access a data record in the memory for a group identified by the code, display an alphanumeric label for the group from the data record, and join a group call involving other radio units in the group.

### BRIEF DESCRIPTION OF THE DRAWINGS

Embodiments of the invention will be described by way of example, and not limitation, with respect to the drawings, in which:

FIG. 1 schematically shows radios being regrouped in a communication system,

FIG. 2 shows a management terminal in the communication system,

FIG. 3 shows messages transmitted and received by the management terminal during a typical regroup procedure,

FIGS. 4A and 4B show how a group label may be displayed during a call,

FIGS. 5A to 5E show how a dispatcher may create and label a new group, and

FIG. 6 shows the content of a regroup message.

### DETAILED DESCRIPTION

It will be appreciated that the invention can be implemented in a range of different ways in a variety of different radio communication systems, such as systems having different network infrastructure or different configurations of the dispatcher. The term group can also apply to either a talkgroup or datagroup. The embodiments described here are given by way of example only. It will also be appreciated that the known components of a mobile radio network need not be described in detail.

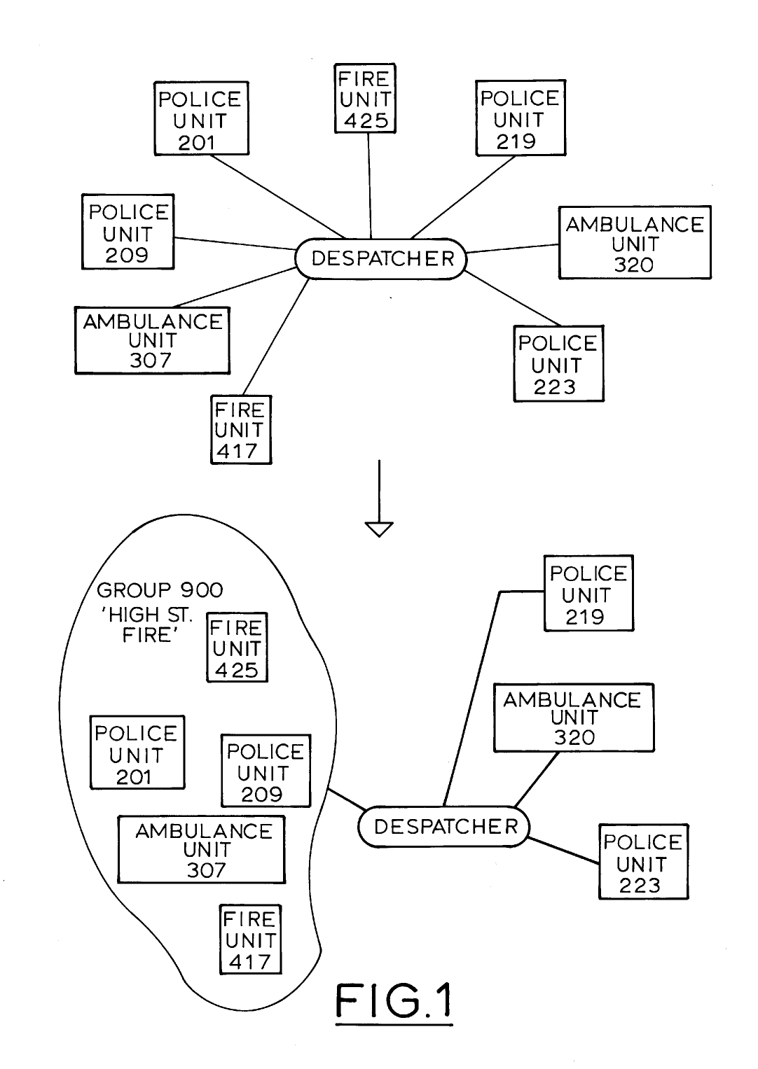

FIG. 1 schematically shows a number of individual radio units in a radio communication system, and how the units may be regrouped by a dispatcher terminal. The radios include typical hardware such as a processor, a memory, a user interface and an RF transceiver. The memory contains software instructions which are carried out by the processor during functions such as placing or receiving a group call, and operating the user interface. Each radio has an identification code or ID which uniquely identifies the unit within the system. These Ms are typically numerical and are not usually changed once they have been assigned to a particular radio. The units with IDs 201, 209, 219 and 223 are in use by police officers. Units 307 and 320 are use by ambulances. Units 417 and 425 are in use by the fire department. In this example the dispatcher selects units 201, 209, 307, 417, 425 to form a temporary group, having an identification code 900, in response to an emergency which the dispatcher has named “HIGH ST. FIRE”. The units in this group can now be called together and can talk together by initiating a call to ID 900. They can also be called separately as before. Network infrastructure such as trunked repeater sites has been omitted for clarity in this diagram.

The dispatcher terminal carries out a variety of tasks concerning management of the communication system. These typically include management of incoming live (ie in-progress), queued or received calls of different types, namely voice calls, data calls, status calls. It also provides the ability to initiate outgoing voice, status, data (referred to as ‘SDM’ or Short Data Message) calls. Additional administration tasks also include maintenance of a fleet address book showing the relationship between ID numbers and the names of entities, monitoring of in-progress calls and the ability to create dynamic groups.

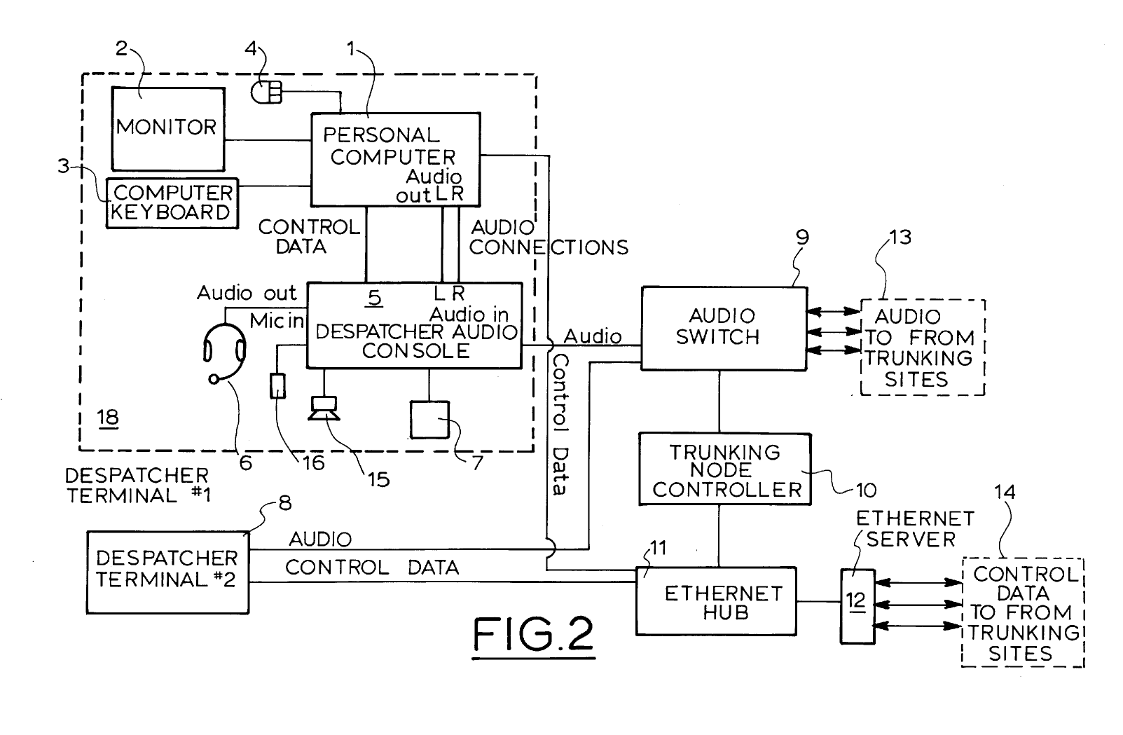

FIG. 2 shows the main components of a dispatcher terminal 18 which could be used in the system of FIG. 1, and how the terminal is typically connected to the network infrastructure. The terminal includes a personal computer 1 having hardware such as a processor coupled to a memory, and connected to standard peripherals such as a display 2, keyboard 3, and mouse 4. The memory contains a software application which includes a set of instructions for the features which are available to the dispatcher. In particular, the instructions enable the processor to provide features related to regrouping, including creation of data records for new groups and initiation of regroup messages to the network.

The personal computer 1 in FIG. 2 is connected to an audio console 5 by bi-directional audio connections and by a serial connection for control data. The console provides audio received from the network infrastructure to the operator via speakers in a headset 6 and/or speaker 15, and conveys audio from the operator to the network via a microphone in the headset or a separate microphone 16. The operator can also control transmit and receive “push to talk” (PTT) operation by a footswitch 7.

The terminal 18 in FIG. 2 communicates bi-directional audio signals from the console 5 to the network via an audio switch 9. Control information is communicated from the personal computer 1 to the network via an Ethernet hub 11 and server 12. The control information includes messages relating to regrouping procedures, which are sent to individual radios or as a broadcast to an existing group of radios. A trunking node controller is in overall control of operation of the network infrastructure. Additional dispatcher terminals, such as terminal 8, may be provided in some communication systems. It will also be appreciated that the terminal shown in this example is commonly known as a “line dispatcher”, being wired directly to the switch 9 and hub 11. Alternative configurations such as a “radio dispatcher” which is connected wirelessly to the network via a mobile radio are also often used.

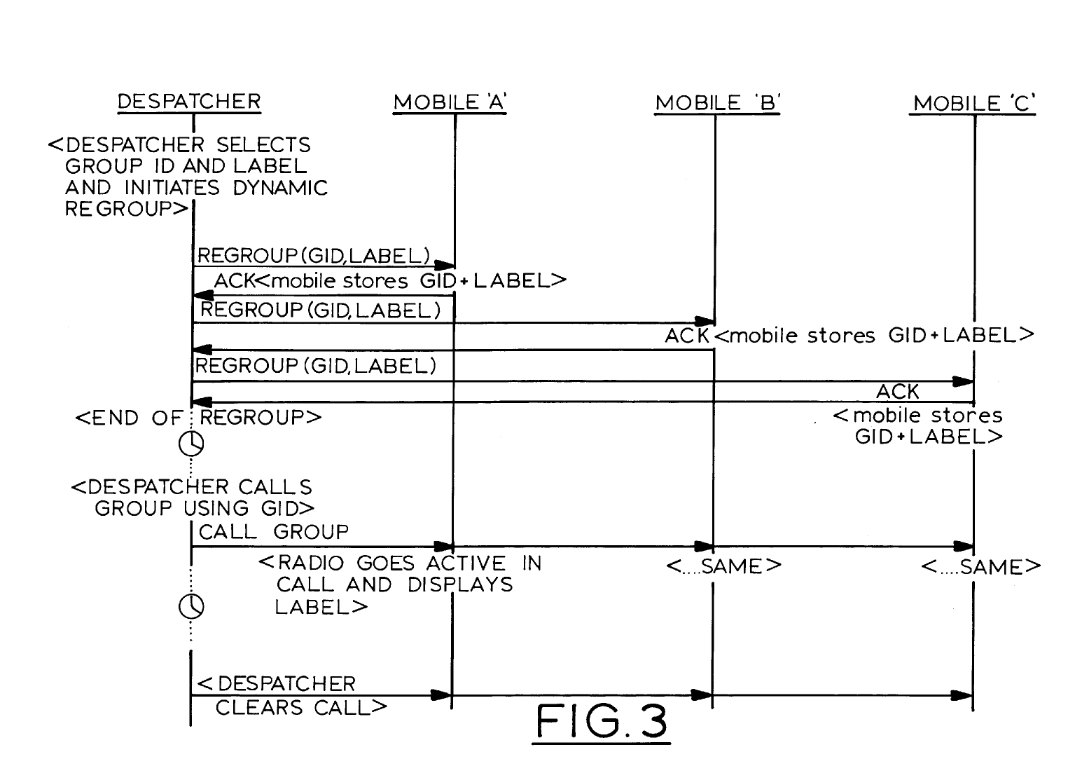

FIG. 3 is a sequence diagram showing control messages which are sent between the dispatcher terminal and mobile radios, via the network infrastructure, during a regrouping procedure such as indicated in FIG. 1. The operator carries out these steps using a computer and associated equipment such as shown in FIG. 2. A number of different protocols will usually be involved for communications between the computer and Ethernet hub, between the hub and the repeaters, and over the air to the radios. The operator first selects two or more mobile radios to form a new group, which has three radios A, B, C in this example, and allocates a group identification code, such as 900 in FIG. 1. Some groups may have dozens or hundreds of members. The dispatcher also determines a label for the group, which is intended to be meaningful to the radio users, typically an alphanumeric label such as “HIGH ST. FIRE” in FIG. 1. Messages containing the group ID and the label are sent individually to the radios in this case, and individually acknowledged. The data is stored in each radio as a new data record. Variations are possible, such as separate messages containing the group ID and the label, for example. The operator may then initiate a call to the radios in the new group, during which the ID and/or label is usually displayed to the radio users. The users may also initiate group calls using the ID and label received from the dispatcher.

In some cases the dispatcher may vary the members of a group and/or update the group label as circumstances relating to the purpose of the group change. The group indicated “HIGH ST. FIRE” might no longer require communication with the ambulances once any injured parties have been conveyed to a hospital. The group might be relabelled “DOWNTOWN FIRE” for example, if the fire spreads to other neighbourhoods. These changes may be implemented by additional messages or simply by cancelling the current group and forming an entirely new group:

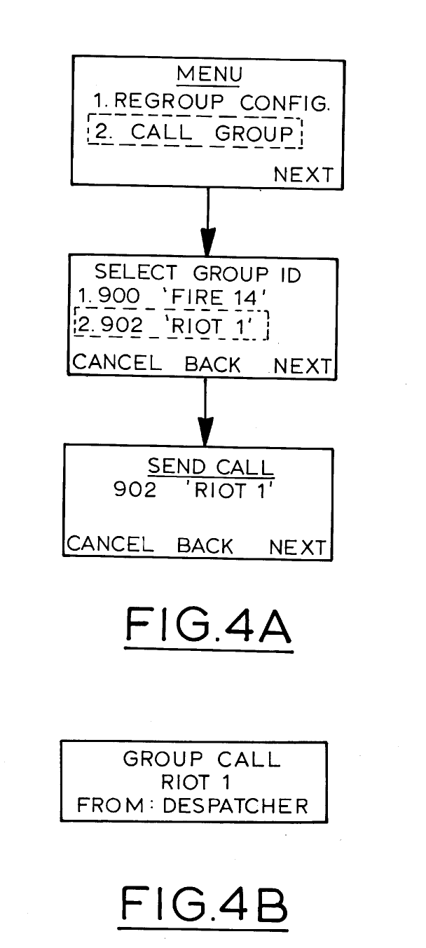

FIG. 4A indicates a series of views which may be displayed at the dispatcher terminal when a group call is initiated by the operator. These views are typically provided in a relatively small portion of a screen which also contains multiple pieces of information about the current status of the overall communication system, but the content may be indicated in a range of different ways. In this case the operator selects “call group” from a first menu, then selects group “902” which is labelled “RIOT 1”, from a second menu, and sends a call to the group. Radios in the group join the call, according to the actions taken by their users. The group label and the status of the radios may be indicated on the screen until the call is cleared or times out.

FIG. 4B shows a typical view which may be displayed at a radio which is participating in a group call, initiated by the dispatcher in this example. The memory of the radio contains data giving associations between numeric IDs and any related alphanumeric labels. The group label is displayed in preference to the group ID, and is likely to be more meaningful to a user who may be part of several different groups. The origin of a call is also usually displayed according to the ID of the dispatcher or the radio which initiated the call.

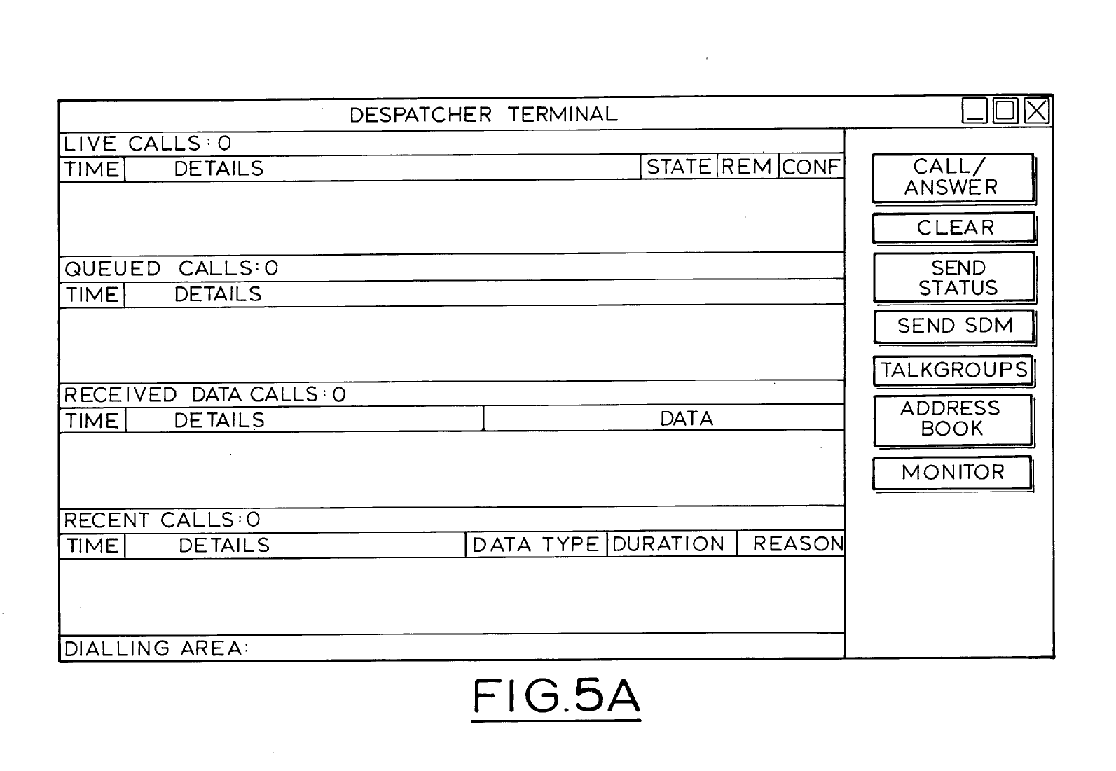

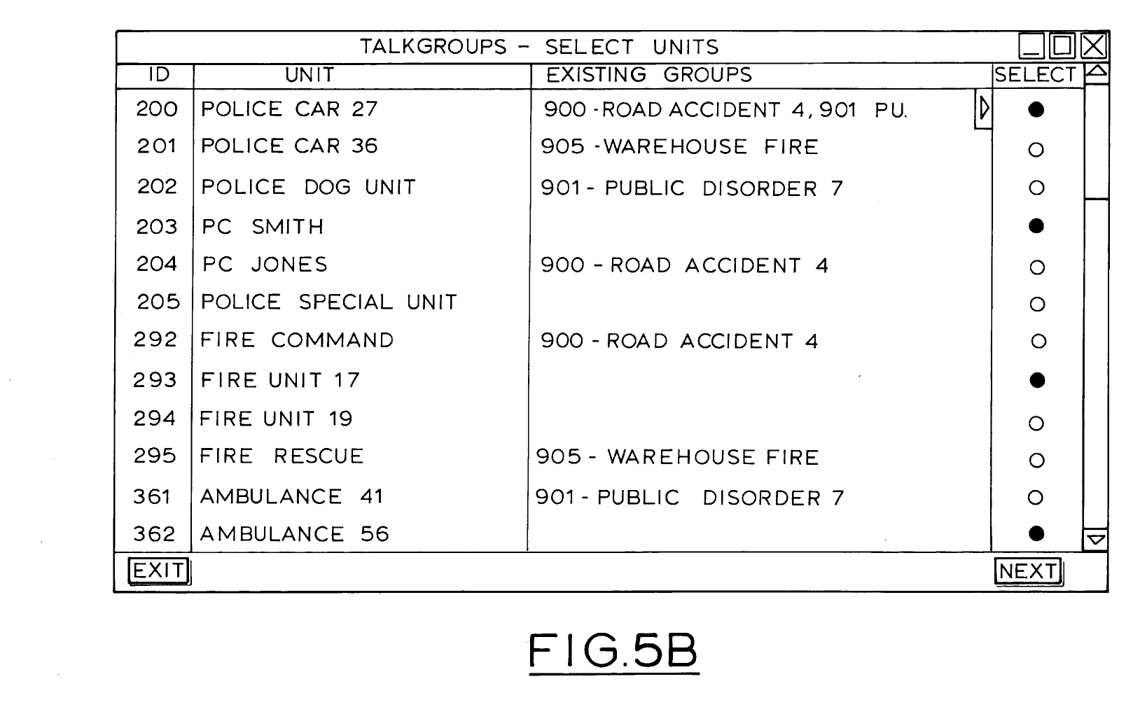

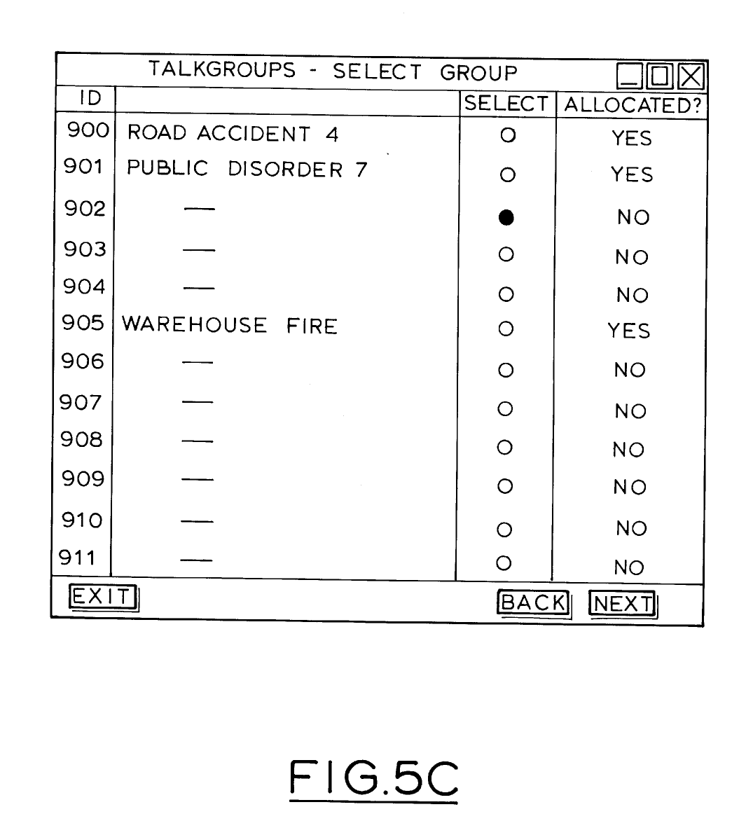

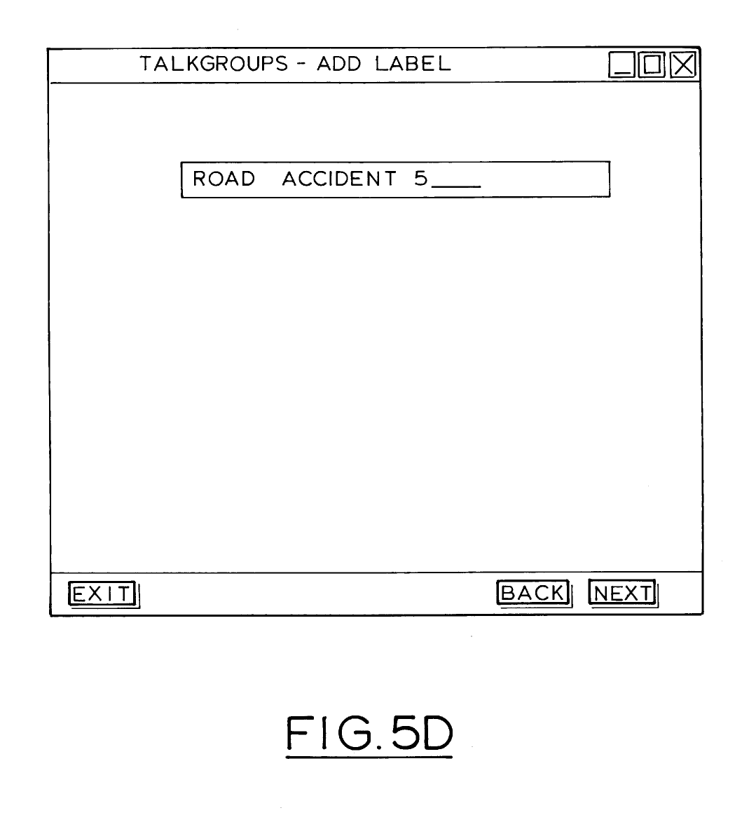

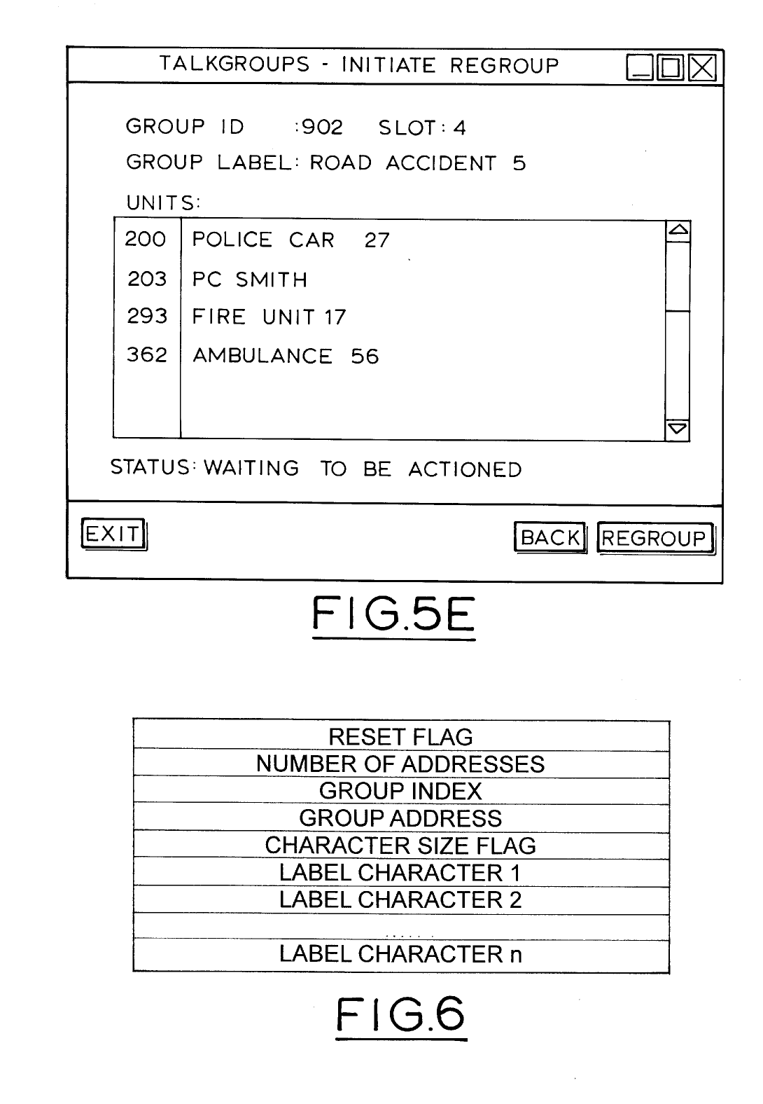

FIGS. 5A to 5E show a series of views which may be displayed at the dispatcher terminal during a regroup procedure. The content of these views may be indicated in a range of different ways. FIG. 5A shows the main terminal screen indicating live calls, queued calls, data and recent calls for example, and having a range of options including “TALKGROUPS”. FIG. 5B shows a “TALKGROUPS—SELECT UNITS” screen which provides a scrollable list of radio units in the system and their existing groups. It shows unit IDs and names, and their associated group IDs and names, and allows the operator to select units for a new group which is being formulated. Units 200, 203, 293 and 362 are shown selected in this case. Selecting “NEXT” enables a selection of groups. FIG. 5C shows a “TALKGROUPS—SELECT GROUP” screen which provides a list of available group IDs that may be allocated for dynamic groups. It shows group IDs and labels, and allows the operator to select an ID for a new group. Groups 900, 901 and 905 are currently allocated and 902 has been selected in this case. Selecting “NEXT” enables a label to be added. FIG. 5D shows a “TALKGROUPS—ADD LABEL” screen which provides an input area for an alphanumeric string which is to be associated with the previously selected group ID as a label. Text reading “ROAD ACCIDENT” has been entered in this case. A similar screen would be shown when updating an existing label. Selecting “NEXT” enables the regrouping to be initiated via the network.

FIG. 5E shows a “TALKGROUPS—INITIATE REGROUP” screen which provides a summary of the information selected and entered by the operator, as a means of confirming that all is correct prior to initiating the regroup messaging through the network. It shows the group ID and a respective slot. The slot is allocated by the dispatcher software and refers to a location within a radio group table where the information will be stored. The screen also shows a list of units which will comprise the group and which will receive the regroup message. A “STATUS” field shows the progress of the regroup procedure, in this case “Waiting to be Actioned”. Selecting “REGROUP” directs the software to request that the appropriate on-air messaging is generated and transmitted to the listed units. The status will then read “In progress” and the “EXIT”, “BACK” and “REGROUP” keys will be removed and replaced by a single “CANCEL” key.

Selecting “CANCEL” in FIG. 5E will cancel the regroup operation but is likely to leave the system in an indeterminate condition as some units may have been regrouped but others may not. In this case the status will change to show ‘Regroup Failed’ and the “EXIT”, “BACK” and “REGROUP” keys will be reinstated. The dispatcher software will track the acknowledgements received from individual units such that it can determine which units will require regroup messages to be sent to them in the case of the user re-trying the regroup operation by selecting “REGROUP” once again.

A regroup procedure may also fail for other reasons such as poor RF conditions. In this case the same scenario as described above applies. If the regroup procedure succeeds, and all units have individually acknowledged the procedure, the status will change to ‘Regroup Operation Complete’ and only the “EXIT” key will be presented.

FIG. 6 shows data content of a typical regroup message sent by the dispatcher terminal to a radio, via the network, during a regroup procedure. The fields in this message contain data as follows:

RESET FLAG—Indicates whether to reset all groups prior, to programming new addresses.

i. Range; 0 or 1.

ii. 0—Do not reset i.e., only overwrite with new address.

iii. 1—Reset all addresses to 0 prior to writing new address.

NO. OF ADDRESSES—Number of group addresses in this message
i. Range; 0-1.
ii. 0 value valid only for if Write operation is ‘reset’ only (ie no write of a new address).

GROUP INDEX—References group position to be changed in radio group table.

i. Range 0-15.

ii. Can reference up to 16 groups.

GROUP ADDRESS—Group address.

i. Range—24-bit address.

ii. 0 value means ‘remove group address from table’.

CHARACTER SIZE FLAG—Indicates whether to use 8-bit ASCII or 16-bit Unicode characters

i. to convey a group label.

ii. Range; 0 or 1.

iii. 0-8 bit characters.

iv. 1-16 bit characters.

LABEL CHARACTER—Multiple 8-bit ASCII or 16-bit Unicode characters as required to

i. convey a group label.

What is claimed is:

1. A method of grouping radio units in a radio communication system, including:
selecting one or more radio units in the system to form a group,
selecting an identification code for the group,
determining an alphanumeric label for the group,
sending a new group message to each of the selected radios, containing the identification code and the label, and
storing the code and the label at each of the selected radios.

2. A method according to claim 1 further including:
determining a new alphanumeric label for the group,
sending an update message to the radios in the group, containing the identification code and the new label, and
updating the label stored at each radio in the group.

3. A method according to claim 1 further including:
initiating a call to the group, and
displaying the label at one or more of the units during the call.

4. A dispatcher terminal for a radio communication system, including:
a processor, and
a memory coupled to the processor for storing instructions which when executed enable the processor to:
indicate radio units available for a new group in the communication system,
receive a selection of one or more radio units from the available units,
indicate available group identification codes for the new group,
receive a selection of a code from the available identification codes,
display an input area for an alphanumeric label for the new group,
receive an alphanumeric label from the input area,
create a data record representing the new group in the memory, and
send a regrouping message to each of the selected radio units in the new group, containing the group code and the alphanumeric label.

5. A terminal according to claim 4 wherein the instructions further enable the processor to:
indicate existing groups in the communication system,
receive a selection of a group from the existing groups,
display an input area for a new alphanumeric label for the selected group,
receive an alphanumeric label from the input area,
update a data record representing the group in the memory with the received label, and
send an update message to each radio in the group, containing the group identification code and the new alphanumeric label for the group.

6. A terminal according to claim 4 wherein the instructions further enable the processor to:
indicate existing groups in the communication system,
represent each existing group with an identification code and an alphanumeric label,
receive a selection of a group from the existing groups, and
initiate a group call to the selected group.

7. A radio unit for a radio communication system, including:
a processor, and
a memory coupled to the processor for storing instructions which when executed enable the processor to:
receive a regrouping message from a dispatcher terminal, containing a group identification code and an alphanumeric label for a new group, and
create a data record in the memory representing the new group.

8. A radio unit according to claim 7 wherein the instructions further enable the processor to:
receive an update message containing a group identification code and a new alphanumeric label for a group,
access a data record in the memory for a group identified by the code, and
update the data record with the new alphanumeric label.

9. A radio unit according to claim 7 wherein the instructions further enable the processor to:
receive a group call message containing a group identification code,
access a data record in the memory for a group identified by the code,
display an alphanumeric label for the group from the data record, and
join a group call involving other radio units in the group.
